(19) United States
(12) Patent Application Publication
(10) Pub. No.: US 2003/0041741 A1
(43) Pub. Date: Mar. 6, 2003

(54) Separable handle for cooking vessel and cooking vessel

(76) Inventor: Jong Peter Park, Diamond Bar, CA (US)

Correspondence Address: HOGAN & HARTSON L.L.P., 500 S. GRAND AVENUE, SUITE 1900, LOS ANGELES, CA, 90071-2611, US

(21) Appl. No.: 10/122,473

(22) Filed: Apr. 12, 2002

(30) Foreign Application Priority Data
Aug. 9, 2001 (KR) 2001-47975

(51) Int. Cl. A23L 1/00

(52) U.S. Cl. 99/337; 99/403

(57) ABSTRACT

Disclosed is a separable handle for a cooking vessel in a cooking vessel handle detachable to a vessel having a coupling link according to the present invention including a handle body having a coupling recess at one end wherein the coupling link of the vessel is inserted into the coupling recess, a locking means coupled with the handle body, the locking means locking the coupling link inserted into the coupling recess, and an unlocking means coupled with the handle body, the unlocking means releasing the locking means.

### BACKGROUND OF THE INVENTION

1. Field of the Invention

The present invention relates to a separable handle for a cooking vessel and a cooking vessel having the same, and more particularly, to a handle structure separable from a lateral side of a cooking vessel with ease.

2. Background of the Related Art

Most of handles for cooking vessels are fixed to the vessels permanently.

A technique of coupling a detachable handle with a cooking vessel is disclosed in Korean Utility Laid-open No. 20-2001-215672.

In the cooking vessel handle according to the laid-open Utility, a support piece is fixed to a body, a sliding pressing plate is established at the back side of the support piece so as to be elastically supported by a spring backward, and a lever is installed at a back of the pressing plate so that a back end of the pressing plate slides back and forth along a concave guiding surface and a hooking groove of the lever, thereby enabling the handle to engage/disengage a vessel rim.

The above-constructed handle for a cooking vessel is inconvenient for portability in a narrow space due to the long handle itself as well as unstable in holding the cooking vessel due to the weakened coupling force between the support piece and pressing plate as the elasticity of a coiled spring supporting elastically the pressing plate.

### SUMMARY OF THE INVENTION

Accordingly, the present invention is directed to a separable handle for cooking vessels that substantially obviates one or more of the problems due to limitations and disadvantages of the related art.

The object of the present invention is to provide a separable handle for cooking vessels and a cooking vessel having the same.

In the present invention, it is intended that a handle is separated from a cooking vessel to reduce a volume of the cooking vessel so as to enable the cooking vessel to be transferred to a small space such as an oven, a microwave oven, and the like and that a cooking vessel is safely transferred to another place by having a handle to be coupled with a coupling link attached to a lateral side of the cooking vessel.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages, and in accordance with the purpose of the present invention as embodied and broadly described, a separable handle for a cooking vessel in a cooking vessel handle detachable to a vessel having a coupling link according to the present invention includes a handle body having a coupling recess at one end wherein the coupling link of the vessel is inserted into the coupling recess, a locking means coupled with the handle body, the locking means locking the coupling link inserted into the coupling recess, and an unlocking means coupled with the handle body, the unlocking means releasing the locking means.

In another aspect of the present invention, a cooking vessel in a cooking vessel having a separable handle includes a cooking vessel body, a coupling link attached to the cooking vessel body, and a cooking vessel handle. And, the cooking vessel handle includes a handle body having a coupling recess at one end wherein the coupling link of the vessel is inserted into the coupling recess, a locking means coupled with the handle body, the locking means locking the coupling link inserted into the coupling recess, and an unlocking means coupled with the handle body, the unlocking means releasing the locking means.

Preferably, the coupling link is rotated to be folded/unfolded between the first and second positions parallel with the cooking vessel body. Therefore, the coupling link having a rectangular cross-section moves rotationally to the second position so as to reduce a spatial volume as well as provide a fine look.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a layout of a cooking vessel handle;

FIG. 2 illustrates a front view of a cooking vessel handle;

FIG. 3 illustrates a profile of a cooking vessel handle;

FIG. 4 and FIG. 5 illustrate cross-sectional views of a cooking vessel handle in part;

FIG. 6 illustrates a layout of a cooking vessel handle engaging/disengaging the cooking vessel; and

FIG. 7A and FIG. 7B illustrate cross-sectional views of an unfolded coupling link and a folded coupling link, respectively.

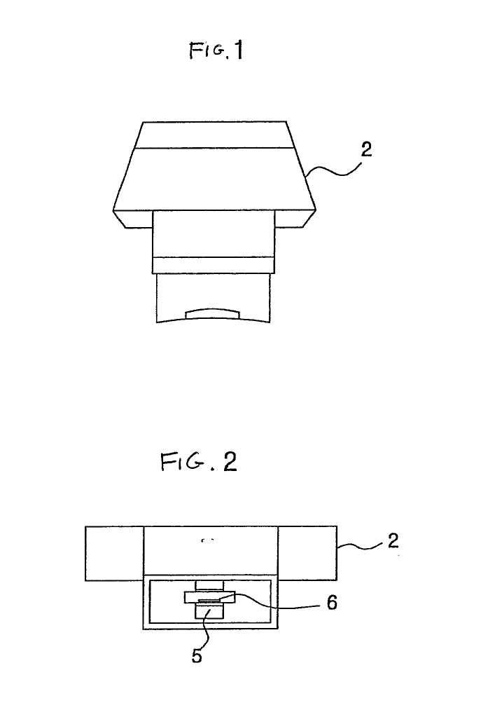

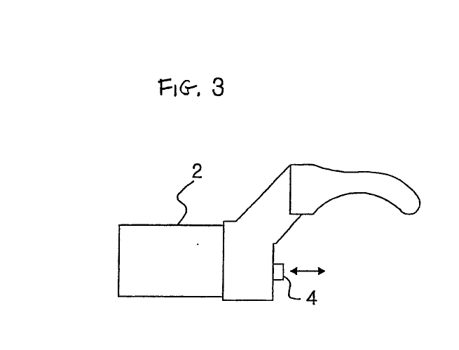

### DETAILED DESCRIPTION OF THE PREFERRED EMBODIMENTS

Reference will now be made in detail to the preferred embodiments of the present invention, examples of which are illustrated in the accompanying drawings. Where possible, the same reference numerals will be used to illustrate like elements throughout the specification.

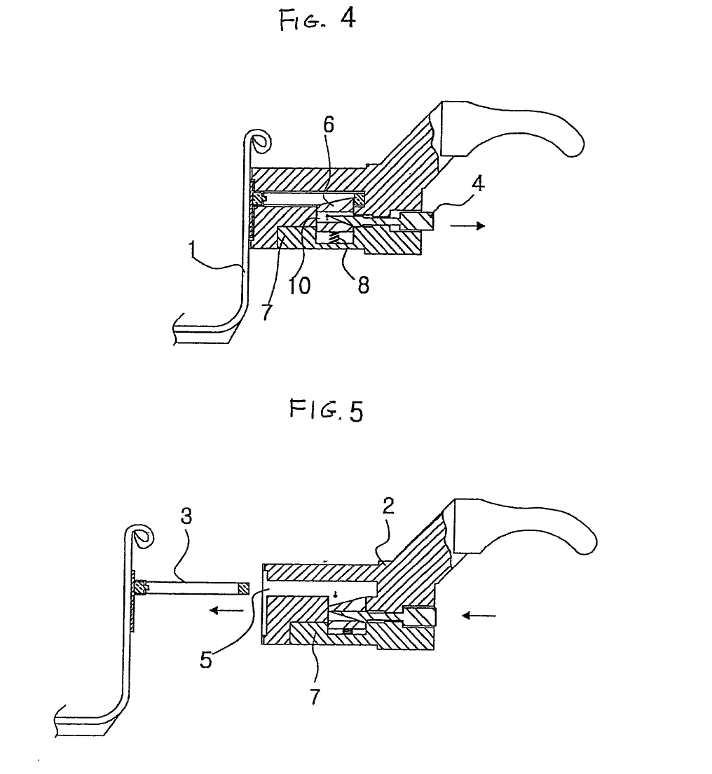

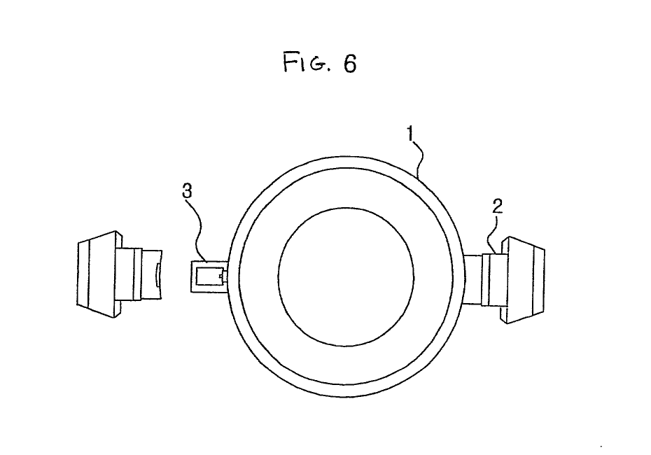

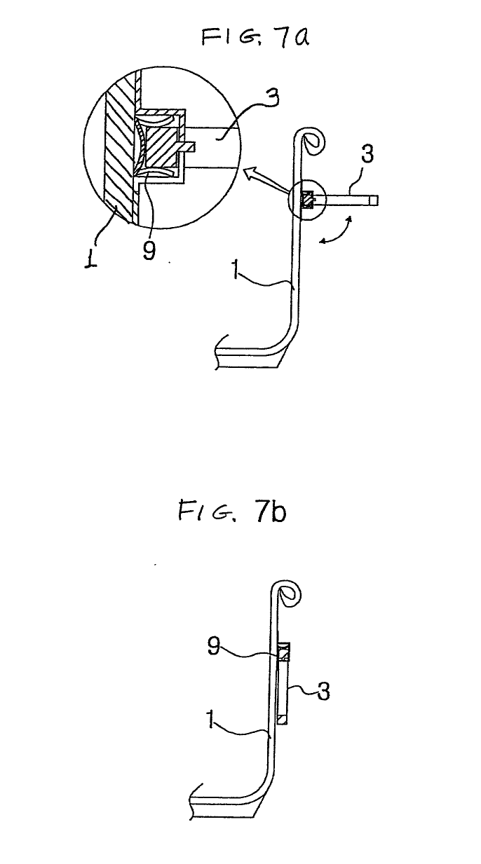

FIG. 4 and FIG. 5 illustrate cross-sectional views of a cooking vessel handle in part, FIG. 6 illustrates a layout of a cooking vessel handle engaging/disengaging the cooking vessel, and FIG. 7A and FIG. 7B illustrate cross-sectional views of an unfolded coupling link and a folded coupling link, respectively.

A handle for a cooking vessel according to the present invention is used as a handle for transporting the cooking vessel 1 by being combined with a coupling link 3 attached to an external circumference of the cooking vessel 1. And, the handle is folded at the lateral side of the cooking vessel so as to be stored in a small space.

Inside a handle body 2, a locking means 6 and an operation lever 4 are installed so as to fix the coupling link 3 thereto and a space is provided for accommodating and fixing the locking means 6 and an unlocking means.

At a front face of the handle body 2, a coupling recess 5 is formed so as to enable the coupling link 3 to be inserted into.

At a back face of the handle body 2, a push button of the operation lever 4 for releasing the assembly with the coupling link 3 of the vessel 1 protrudes out.

And, a bottom face of the handle body 2 is covered with a lower plate 7 for fixing the operation lever 4 and locking means 6 installed inside the handle body 2.

The coupling link 3 is installed at a lateral side of the vessel 1 and constructed so as to engage/disengage the handle body 2. The coupling link 3 protrudes out of the lateral side of the vessel 1 so as to engage the handle body 2. When disengaging the handle body, the coupling link enables to be folded with rotational movement right and left or up and down. Moreover, the coupling link 3 and a plate spring 9 are accommodated in a spring case attached to a circumference of the vessel 1 by welding. The coupling link 3, as shown in FIG. 6 and FIG. 7A, may be placed at a first position to be coupled with the handle. The coupling link 3, as shown in FIG. 7B, enables to move rotationally by being folded to a second position in parallel with a surface of the vessel 1. The “ [symbol] ” type plate spring 9 permits the coupling link 3 to be located either the first or second position.

The locking means 6 includes a plunger 6 of which head is slant upward from an entrance of the coupling recess 5 and a plunger spring 8 pushing the plunger 6 all the time. A groove 9 is formed at the plunger 6. The head of the plunger 6 protrudes inside the coupling recess 5 by a force of the plunger spring 8 placed below. A shape of the protruding head is like an upwardly-smooth inclination. Thus, the plunger 6 enables the coupling link 3 to be inserted therein with ease.

The unlocking means includes a groove 9 formed at a portion of the plunger 6 and the operation lever 4 retreating the plunger head from the coupling recess 5 by pushing the operation lever 4. Therefore, the coupling link 3 fails to be fixed since the plunger 6 is drawn back from the coupling recess 5. On the other hand, when an external force working on the protruding part of the operation lever 4 is removed, the plunger 6 moves upward by the elasticity of the plunger spring 8. Thus, the operation lever 4 is retreated.

Besides, the coupling link 3 has a plane plate shape having a hole that the plunger head enters sufficiently. Instead, the coupling link 3 may be formed by bending a square pillar.

As the elastic force of the plunger spring 8 installed between the bottom plate 7 and the plunger 6 is applied to the plunger 6 to move upward, a tail part of the operation lever 4, i.e. the push button part, is pushed back outside the handle body 2 while the slant surface of the head of the operation lever 4 is pushed.

The plunger spring 8 is inserted into the coupling recess 5 until reaching a predetermined depth therein. Namely, a front face of the coupling link 3 presses the head of the plunger 6 so as to compress the plunger spring 8, whereby the head descends. Then, the front face of the coupling link 3 passes the head of the plunger 6 so as to protrude out of a middle part of the coupling link 3. Therefore, the coupling link 3 is fixed thereto.

When the coupling link 3 lies at the second position in parallel with the lateral side of the vessel 1 which is very hot, a small protrusion may be formed in order to displace the coupling link 3 to the first position without touching the vessel 1. In this case, a path should be provided in the coupling recess 5 additionally so that the protrusion slides through.

Moreover, the coupling link 3 may have a feature of which middle part of the upper front, which is inserted into the coupling recess 5 of the handle body 2 by being unfolded, is convex or of which both lateral sides are convex upwardly. In both cases of forming the shapes of the coupling link 3, the front face of the coupling recess 5 of the handle body 2 should be amended so as to enable the insertion of the modified coupling link 3.

The plate spring 9 is preferably like the “ [symbol] ” type so as to secure the operation and the fixing force of the position of the coupling link 3. Yet, it is optional to form the plate spring 9 like the “ [symbol] ” type. Instead, the plate spring 9 may be formed suing a plane type plate spring.

Operation of the embodiment of the present invention follows.

When the handle is fastened to the vessel 1 to make the coupling link 3 enter the coupling recess 5 of the handle, the vessel and handle are assembled each other. When the protruding button of the operation lever 4 is pressed, the assembly is released.

Looking into the operation in detail, the coupling link 3 enters the coupling recess 5 to push the head of the plunger 6 to the end. The head pops up by the spring force so that the coupling link 3 is locked into the coupling recess 5. Thus, the coupling link is unable to escape from the coupling recess 5.

While the locked state is maintained, a user enables to displace the cooking vessel by grabbing the handle.

In order to release the assembly between the vessel and handle, the handle is pulling back while the button of the operation lever is pressed.

After releasing the assembly of the handle, the protruding coupling link rotates to be folded to the second position. Therefore, the vessel is more conveniently stored with less interference of other articles in storage as well as provides a fine look.

Accordingly, the handle according to the present invention is detachable from a cooking vessel, thereby enabling to reduce a volume of the cooking vessel for the convenience of storing the cooking vessel in an insufficient space such as microwave, kitchen shelf or the like.

Moreover, the handle according to the present invention is just attached to a cooking vessel for transportation, thereby providing a convenient usage.

Further, the handle according to the present invention easily engages/disengages a cooking vessel as well as secures the coupling therebetween, thereby enabling to prevent an accident caused by the sudden disengagement on transferring the vessel.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. In a cooking vessel handle detachable to a vessel having a coupling link, a separable handle for a cooking vessel, comprising:
a handle body having a coupling recess at one end wherein the coupling link of the vessel is inserted into the coupling recess;
a locking means coupled with the handle body, the locking means locking the coupling link inserted into the coupling recess; and
an unlocking means coupled with the handle body, the unlocking means releasing the locking means.

2. The separable handle for a cooking vessel of claim 1, the locking means comprising:
a plunger having a slant head; and
a plunger spring pushing the plunger so that the head protrudes inside the coupling recess,
wherein the slant head of the plunger is pushed back by an entering force of the coupling link inserted into the coupling recess and then enters a hole of the coupling link when the coupling link is completely inserted so as to prevent the coupling link from retreating.

3. The separable handle for a cooking vessel of claim 1, the unlocking means comprising an operation lever having a slant head inserted into a groove formed at a body of the plunger wherein the coupling link is released from locking so that the operation lever is displaced to make the head of the plunger retreats from the coupling recess.

4. In a cooking vessel having a separable handle, the cooking vessel, comprising:
a cooking vessel body:
a coupling link attached to the cooking vessel body; and
a cooking vessel handle, comprising:
a handle body having a coupling recess at one end wherein the coupling link of the vessel is inserted into the coupling recess;
a locking means coupled with the handle body, the locking means locking the coupling link inserted into the coupling recess; and
an unlocking means coupled with the handle body, the unlocking means releasing the locking means.

5. The cooking vessel of claim 4, wherein a cross-section of the coupling link is circular or polygonal and wherein one end of the coupling link is attached to a lateral side of the cooking vessel body so as to move rotationally.

6. The cooking vessel of claim 5, wherein the coupling link moves rotationally using a spring case having a “ [symbol] ” type plate spring and wherein the spring case is attached to the lateral side of the vessel body.
